(19) United States
(12) Patent Application Publication
(10) Pub. No.: US 2009/0150789 A1
(43) Pub. Date: Jun. 11, 2009

(54) Dynamic multi-platform monitoring client for WSD-enabled devices

(76) Inventor: Alain Regnier, Sunnyvale, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/953,728

(22) Filed: Dec. 10, 2007

(51) Int. Cl. G06F 3/048; G06F 15/173

(52) U.S. Cl. 715/736; 709/224

(57) ABSTRACT

In an embodiment, a monitoring application monitors the status of multiple web services provided by multiple WSD-enabled devices in a network. WSD-enabled devices are devices that implement some Web services specifications, such as WS-Discovery, WS-MetadataExchange, and WS-Eventing. The monitoring application also implements some of the core Web services specification so that the monitoring application can communicate with the WSD-enabled devices. The monitoring application discovers web services provided by the WSD-enabled devices, some of which provide multiple web services. The monitoring application provides a user interface to display status information for each discovered web service that a user desires to monitor. The monitoring application determines events that each service is capable of generating. The monitoring application subscribes to one or more of the events in order to receive notifications of the one or more events from the corresponding web service(s).

### TECHNICAL FIELD

The present disclosure relates to monitoring multiple services provided by multiple WSD-enabled devices in a network.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The World Wide Web (“WWW”) is a global information space. Text documents, images, multimedia and many other items of information, referred to as resources, are identified by short, unique, global identifiers called Uniform Resource Identifiers (“URIs”) so that each can be found, accessed and cross-referenced in the simplest possible way.

The World Wide Web Consortium (“W3C”) is an international consortium that develops standards for the World Wide Web. The W3C defines a “web service” as a software system that is designed to support interoperable machine-to-machine interaction over a network. This definition encompasses many different systems, but in common usage, the term refers to those services that use SOAP-formatted Extensible Markup Language (“XML”) envelopes and that have their interfaces described using Web Services Description Language (“WSDL”). Web services allow devices and applications to communicate with each other over one or more networks without the intervention of any human being, while using the same suite of protocols (e.g., Hypertext Transfer Protocol (“HTTP”)) that a human being would use to communicate with such devices and applications over one or more networks.

The specifications that define web services are intentionally modular, and, as a result, there is no one document that defines all web services. Instead, there are a few core specifications that are supplemented by other specifications as the circumstances and choice of technology dictate. Common core specifications are SOAP, WSDL, WS-Security, and WS-ReliableExchange. Different specifications address different tasks and functions.

SOAP is an XML-based, extensible message envelope format, with bindings to underlying protocols (e.g., HTTP and Simple Mail Transfer Protocol (“SMTP”)). Using XML, SOAP defines how messages should be formatted, so that those messages are formatted in such a way that the recipients of those messages (devices and applications) can understand those messages. SOAP can be used to perform remote procedure calls, for example.

WSDL is an XML format that allows web service interfaces to be described along with the details of those interfaces' bindings to specific protocols. WSDL is typically used to generate server and client code, and for configuration.

WS-Security defines how to use XML encryption and XML signature in SOAP to secure message exchanges.

### SUMMARY

An approach is provided for monitoring the status of multiple web services (herein “services”) that are provided by multiple WSD-enabled devices on a network. One or more of the WSD-enabled devices provide multiple services. The approach may be implemented in a monitoring application that sends discovery messages to the WSD-enabled devices in the network. WSD-enabled devices in the network respond to the one or more discovery messages with an indication of their respective addresses and a list of services that each device provides. The monitoring application displays, in a user interface, a status of each discovered service that a user desires to monitor. The monitoring application also sends subscription requests to multiple services to subscribe to one or more events that the multiple services are capable of generating. When a subscribed-for event occurs, the service that generated the event sends an event notification to the monitoring application, which displays information about the event notification via the user interface.

According to one aspect of the invention, a first discovery message is received from a first WS-enabled device and a second discovery message is received from a second WS-enabled device. The first and second discovery messages conform to a WS discovery protocol. The first discovery message indicates at least a first address of the first WS-enabled device and a first set of one or more services that the first WS-enabled device provides. The second discovery message indicates at least a second address of the second WS-enabled device and a second set of one or more services that the second WS-enabled device provides. One or more first metadata messages are subsequently received about one or more services of the first set of services. One or more second metadata messages are also received about one or more services of the second set of services. The one or more services of the first set of services and the one or more services of the second set of services comprise a plurality of services. Each of the one or more first metadata messages and the one or more second metadata messages (1) conforms to a WS metadata exchange protocol (e.g., WS-MetadataExchange or WS-Transfer) and (2) indicates a set of events that the corresponding service is capable of generating. A first subscription request is then sent, according to a WS eventing protocol, to a first service of the first set of services. The first subscription request is to subscribe for a first event that the first service is capable of generating. A second subscription request is also sent, according to the WS eventing protocol, to a second service of the second set of services. The second subscription request is to subscribe for a second event that the second service is capable of generating. A plurality of events are received from the first service and the second service. The information about the plurality of events is stored and maintained. Event data that indicates that the plurality of events has been generated is displayed, via a graphical user interface. Status data that indicates a status of the first service and the second service is also displayed via the graphical user interface.

### BRIEF DESCRIPTION OF THE DRAWINGS

In the drawings:

FIG. 1 depicts an example network that connects multiple WSD-enabled devices and a software application that monitors those devices, according to an embodiment of the invention;

FIGS. 2A-B depict a flow diagram of the various functions performed by an example monitoring application, according to an embodiment of the invention;

FIG. 3 depicts an example user interface that displays status and other information about discovered WSD-enabled devices and their respective services, according to an embodiment of the invention; and

FIG. 4 depicts a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An approach is provided for monitoring the status of multiple web services (herein “services”) that are provided by multiple WSD-enabled devices in a network. One or more of the WSD-enabled devices provide multiple services. The approach may be implemented in a monitoring application that sends discovery messages to the WSD-enabled devices in the network. The WSD-enabled devices respond to the discovery messages with an indication of their respective addresses and a list of services that each device provides. The monitoring application displays, in a user interface, a status of each discovered service that a user desires to monitor. The monitoring application also sends subscription requests to multiple services to subscribe to one or more events that the multiple services are capable of generating. When a subscribed event occurs, the service that generated the event sends an event notification to the monitoring application, which displays information about the event notification via the user interface.

### WSD-Enabled Device

As used herein, a “WSD-enabled device” is a device that implements the WS-DeviceProfile specification, which is based on WS-Discovery, WS-MetadataExchange, WS-Eventing, WS-Addressing, WS-Transfer, and WS-Policy.

Each WSD-enabled device may maintain the following information: an address, a text description of the device, a list of services, a WSDL file, and a list of events to which a client process may subscribe. The address of a device may be an IP address or any other address that allows clients to send messages and/or requests to the device.

A WSD-enabled device may provide the list of services (that the device hosts) in a WS-Discovery response message that is sent to the monitoring application. The WS-Discovery response message may also include an address of each service provided by the device. One or more port numbers associated with a particular service may distinguish the address of the particular service from other services provided by the device.

A WSD-enabled device may provide the list of events of a particular service (that the device provides) in a metadata response message that is sent to the monitoring application. The metadata response message includes a WSDL file associated with the particular service.

### Example Network of Multiple WSD-Enabled Devices

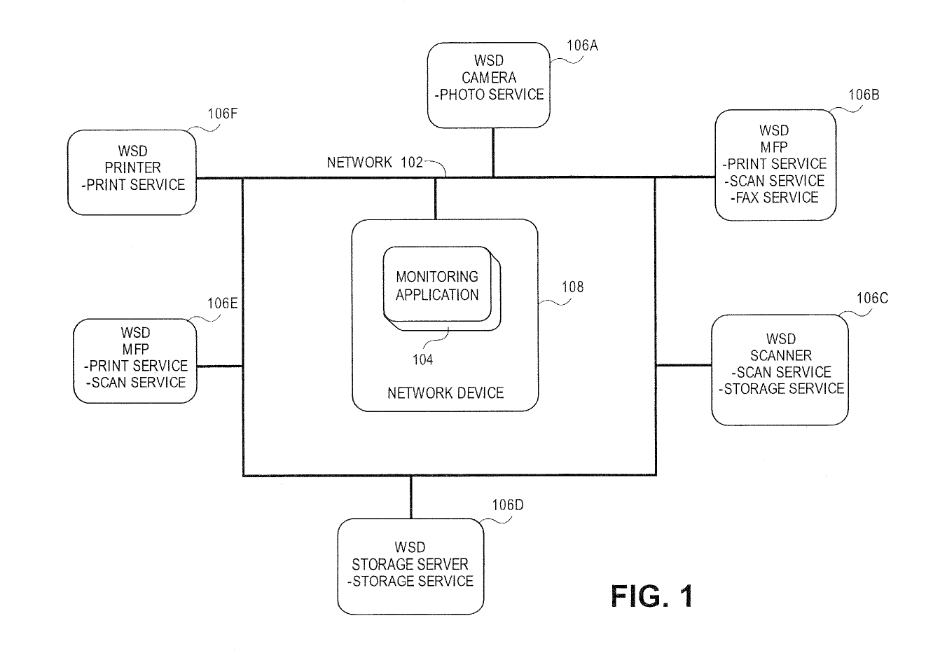

FIG. 1 depicts an example arrangement 100 that includes a network 102 that connects WSD-enabled devices 106A-F and a monitoring application 104 that monitors those devices, according to an embodiment of the invention. Monitoring application 104 is a software application that executes on a network device 108. Monitoring application 104 monitors at least a subset of the services provided, collectively, by WSD-enabled devices 106A-F and displays information about the current status of event service in the subset.

Network device 108 may be any type of network device. Examples of network device 108 include, without limitation, a workstation, a personal computer, a gateway, or a router. Although depicted as executing on a device separate from the WSD-enabled devices 106A-F, for purposes of explanation, monitoring application 104 may execute on any of WSD-enabled devices 106A-F.

Each WSD-enabled device 106 provides (i.e., hosts) one or more services. For example, device 106A is a camera that provides a photo service; device 106B is a multifunction peripheral (MFP) that provides a print service, a scan service, and a fax service; and device 106D is a storage server that provides a storage service.

Network 102 may be implemented by any medium or mechanism that provides for the exchange of data between devices 106A-F and network device 108. Examples of network 102 include, without limitation, a network such as a Local Area Network (LAN), Wide Area Network (WAN), Ethernet or the Internet, or one or more terrestrial, satellite or wireless links.

### Functional Overview

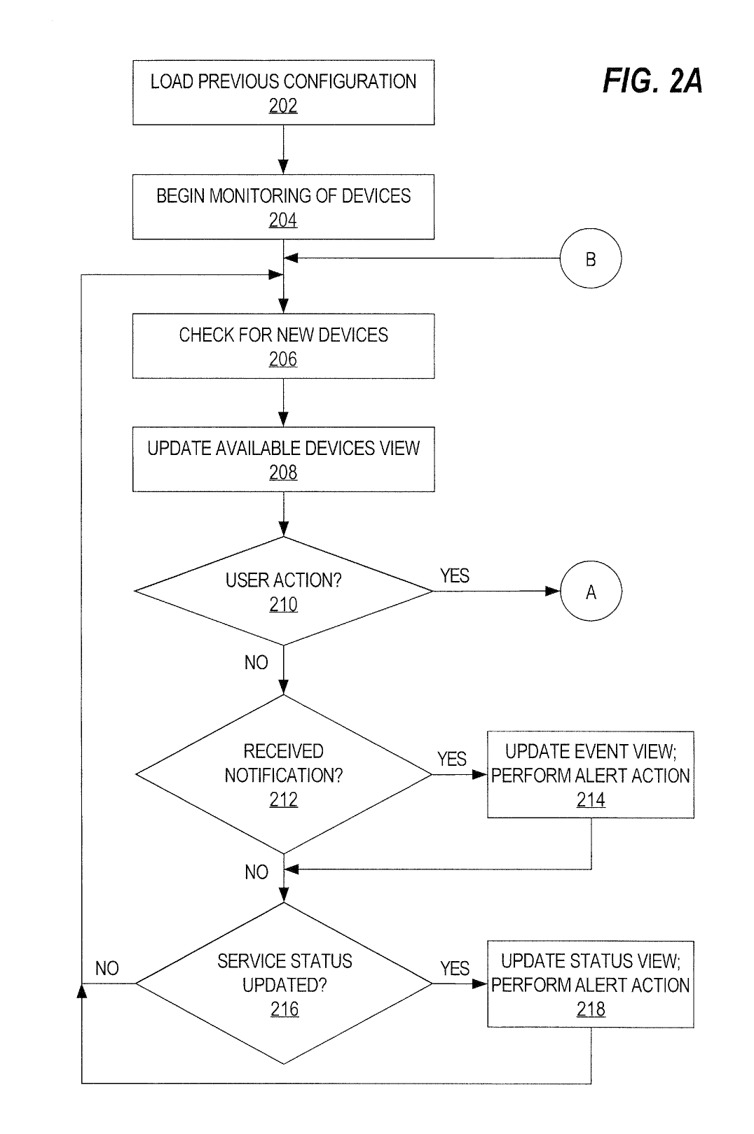

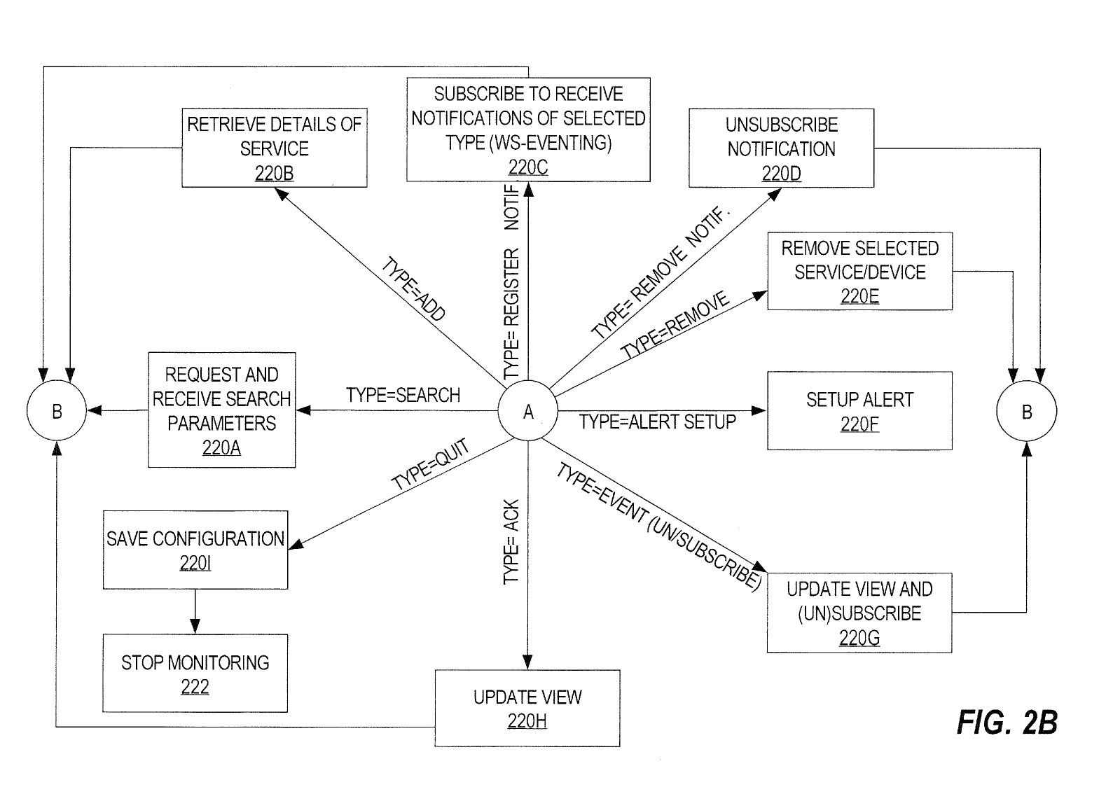

FIGS. 2A-B depict a flow diagram of the various functions performed by an example monitoring application, according to an embodiment of the invention.

At step 202, a previous configuration of a GUI is loaded, e.g., in response to a user selection to open the monitoring application. Alternatively, a previous configuration may not exist (in which case a previous configuration is not loaded). This may be the case when the monitoring application is executed for the first time on a particular machine in a network.

At step 204, any services provided by WSD-enabled devices that were monitored when the monitoring application was last closed are again monitored. If no devices were monitored when the monitoring application was last closed, or if the current execution of the monitoring application is the first execution, then no device is monitored until after the monitoring application (a) discovers a service provided by a device and (b) the monitoring application registers to be notified of one or more events that the service may generate.

At step 206, the monitoring application checks for WSD-enabled devices that are not yet discovered. This step may be performed automatically by the monitoring application or in response to user input. This step may comprise sending a multicast (or broadcast) discovery message that conforms to WS-Discovery or SSDP (Simple Service Discovery Protocol). In response to the discovery message, one or more WSD-enabled devices send a discovery response message to the monitoring application.

Additionally or alternatively, a device sends a HELLO multicast message (e.g., in response to an initial startup) to other devices on the network, which message the monitoring application receives. The HELLO message indicates an address of the particular device and may indicate an endpoint value (e.g., a port number) for each of the services provided by the particular device.

In either scenario, the monitoring application sends a WS metadata request message to one or more “discovered” services. In response, a service provides metadata to the monitoring application (e.g., directly or via a URI returned to the monitoring application). The metadata may include capabilities, requirements, and general characteristics of the service, a WSDL, and a schema that describes the structure and contents of messages received and sent by the service.

At step 208, in response to the discovery response messages from the one or more WSD-enabled devices, the monitoring application updates a view of a GUI that displays available devices and their respective services, such as a fax service, a print service, or a photo service.

At step 210, the monitoring application determines whether user input has been received, such as the selection of a link, button, radio button, or other selectable interface object displayed by the GUI. If so, then the process proceeds to various steps depicted in FIG. 2B, depending on the user input. Such steps are described below.

At step 212, the monitoring application determines whether a notification of an event has been received from a service that the monitoring device is monitoring. If so, then, at step 214, the monitoring application updates an event view of the GUI that displays events that have occurred relatively recently (e.g., over the last day or hour, or the last five events). The event view may display events that a single service has generated or multiple services have generated.

Step 214 may also comprise the monitoring application performing an alert action. Depending on the event and any set-up parameters associated with the event, the monitoring application may perform various actions. For example, a user may configure the monitoring application to send an instant message to a particular instant messenger client when a fax line is disconnected from a WSD-enabled device (e.g., device 106B) that hosts a fax service.

At step 216, the monitoring application determines whether the status of a service has been updated. A status update may be received from a service in the form of an event notification. Alternatively, a status update of a particular service may be determined as the result of not receiving a response to a message sent to that service. Alternatively still, a status update may be received from a particular service according to a communication protocol that is not associated with web services.

If a status of a service has been updated, then the process proceeds to step 218. At step 218, the monitoring application updates a status view of the GUI that displays the status of multiple services that are provided by multiple WSD-enabled devices. Step 218 may also comprise the monitoring application performing an alert action. Depending on the status update and any set-up parameters associated with the status update, the monitoring application may perform various actions. For example, a user may configure the monitoring application to generate a pop-up window when a paper jam occurs on a particular WSD-enabled device (e.g., device 106F) that hosts a print service.

### Steps Performed in Response to User Input

FIG. 2B depicts various steps the monitoring application may perform in response to various types of user inputs. A user input type refers to a type of information indicated by the user input.

If the type of user action is “SEARCH”, then the process proceeds to step 220A. This type of user action may be determined by a user selection of a “SEARCH” button that may be displayed in a view of a graphical user interface (GUI). At step 220A, the monitoring application sends a discovery message to devices in the network and, in response, receives one or more discovery responses from one or more WSD-enabled devices.

If the type of user action is “ADD”, then the process proceeds to step 220B. This type of user action may be determined by a user selection of an “ADD” button that may be displayed adjacent to a service that is discovered, but whose status information is not displayed. A reference to a service that is not displayed in a status view of the GUI may indicate that the status of that service is not monitored. At step 220B, details of the service (e.g., corresponding to the “ADD” button) are added to the status view. Such details may include the name of the service, the name and type of the device that provides the service, and a status of the service.

If the type of user action is “REGISTER NOTIFICATION”, then the process proceeds to step 220C. This type of user action may be determined by a user selection of a “REGISTER NOTIFICATION” button that may be displayed adjacent to a particular event that a particular service is capable of generating. At step 220C, the monitoring application sends a subscription request to the particular service. The subscription request is to subscribe to receive notifications for the particular event.

If the type of user action is “REMOVE NOTIFICATION”, then the process proceeds to step 220D. This type of user action may be determined by a user selection of a “REMOVE NOTIFICATION” button that may be displayed adjacent to a particular event to which the monitoring device is currently subscribed. At step 220D, the monitoring application sends an unsubscribe request to the WSD-enabled device that provides the service associated with the particular event. The unsubscribe request is to unsubscribe from receiving notifications for the particular event.

If the type of user action is “REMOVE”, then the process proceeds to step 220E. This type of user action may be determined by a user selection of a “REMOVE” button that may be displayed adjacent to a particular service or device that the monitoring device is currently monitoring. At step 220E, the monitoring application removes status data of the service (or of all services provided by the device) from the status view. The monitoring application may, in addition to removing status data of the service from the status view, send unsubscribe requests to the removed service to unsubscribe from any currently subscribed-to events that the removed service is capable of generating.

If the type of user action is “ALERT SETUP”, then the process proceeds to step 220F. This type of user action may be determined by a user selection of an “ALERT SETUP” button that may be displayed adjacent to an event (associated with a particular service) to which the monitoring application may or may not be currently subscribed. At step 220F, the monitoring application sets up an alert.

If the type of user action is “EVENT (UN/SUBSCRIBE)”, then the process proceeds to step 220G. This type of user action may be determined by a user selection of an “EVENT (UN/SUBSCRIBE)” button that may be displayed adjacent to an event (associated with a particular service) to which the monitoring application may or may not be subscribed. At step 220G, the monitoring application updates a view (referred to herein as an “available events view”). Also as step 220G, if the monitoring application is not subscribed to the event, then, in response to this type of user action, the monitoring application sends a subscribe request to the service associated with the event. Alternatively, if the monitoring application is subscribed to the event, then, in response to this type of user action, the monitoring application sends an unsubscribe request to the service associated with the event.

If the type of user action is “ACK”, then the process proceeds to step 220H. This type of user action may be determined by a user selection of an “ACK” button that may be displayed adjacent to a particular event: (1) to which the monitoring device is currently subscribed; (2) that was generated by a particular service; and (3) that has not yet been acknowledged by a user. At step 220H, the monitoring application updates a view (referred to herein as an “event history view”) to indicate that the particular event has been acknowledged by the user.

If the type of user action is “QUIT”, then the process proceeds to step 220I. This type of user action may be determined by a user selection of a “QUIT” button (that may be displayed anywhere in the GUI) or a “QUIT” option in a File menu. At step 220I, the monitoring application saves the current configuration, which may include data about the status information displayed in the status view and the service information displayed in the available services view. The process then proceeds to step 222 where the monitoring application quits (i.e., closes).

After any of steps 220A-220H, the process proceeds to step 206, as indicated by the ‘B’ node in FIGS. 2B and 2A.

### Example Graphical User Interface

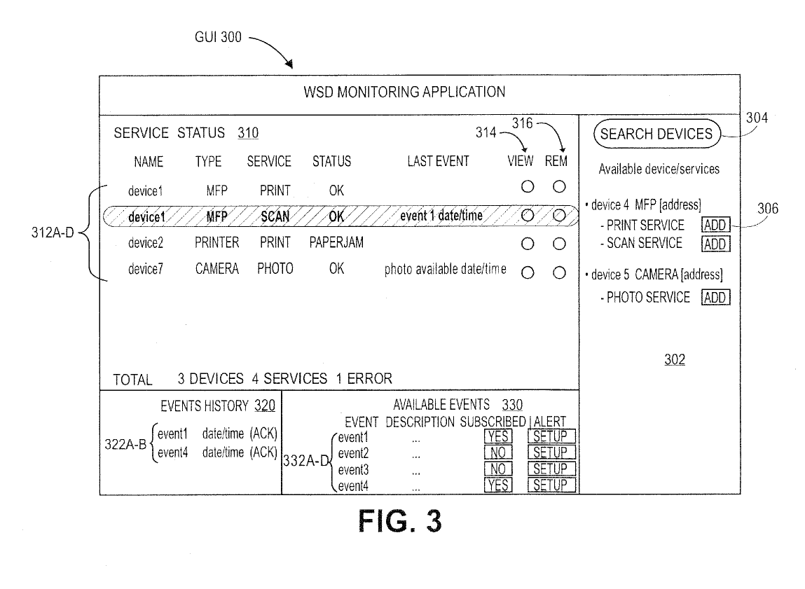

FIG. 3 depicts an example graphical user interface (GUI) 300 that displays status and other information about discovered WSD-enabled devices and their respective services, according to an embodiment of the invention. Monitoring application 104 may be configured to generate GUI 300. For example, monitoring application 104 may generate web pages that are displayed via a browser executing on network device 108 or another network device. If the browser executes on network device 108, the browser may be part of monitoring application 104.

GUI 300 comprises multiple views that each displays various types of information. The multiple views are an available services view 302, a service status view 310, an event history view 320, and an available events view 330.

Although GUI 300 depicts and the following description refers to particular types of interface options, such as buttons and radio buttons, embodiments of the invention are not limited to any particular type of interface option. For example, instead of an “ADD” button 306, the text “PRINT SERVICE” may be a selectable link that adds an entry, corresponding to that print service, to service status view 310.

### Available Services View

Available services view 302 displays information about WSD-enabled devices that have been discovered, but whose details are not yet added to a service status view 310. Available services view 302 comprises a search button 304 that, when selected, sends a discovery message in network 102. The discovery message may be a multicast message or a broadcast message. The discovery message conforms to WS-Discovery or SSDP. A WSD-enabled device that receives the discovery message generates a discovery response that includes information about the WSD-enabled device. Such information may include an address of the WSD-enabled device and an address of each of the services provided by the WSD-enabled device.

Monitoring application 104 receives and processes discovery responses from WSD-enabled devices that respond to the discovery message. Based on each discovery response, monitoring application 104 displays, in available services view 302, the information received from the WSD-enabled devices.

Additionally or alternatively, monitoring application 104 receives a HELLO multicast message from WSD-enabled devices. Thus, such WSD-enabled devices initiate the discovery process. Subsequently, monitoring application 104 requests information about the services provided by the WSD-enabled devices.

Available services view 302 may also comprise a button adjacent to each label that indicates a specific discovered service. As FIG. 3 depicts, an “ADD” button 306 is displayed adjacent to each service displayed in available services view 302, such as print service and scan service of device4 and photo service of device5.

User selection of such an “ADD” button causes information about the corresponding service to be displayed in service status view 310. For example, user selection of “ADD” button 306 adjacent to the displayed print service in available services view 302 causes a new entry to be displayed in service status view 310. The new entry lists different characteristics about the print service, such as a name and type of the device that provides the print service, a type of the service (i.e., print in this example), and the current status of the print service.

### Service Status View

Service status view 310 displays current status information for each service and device that a user desires to monitor. In an embodiment, service status view 310 includes multiple entries 312A-D, one for each service that a user desires to monitor. Each entry 312 includes data about the corresponding service, such as a name of the device that provides the service, a type of the device, a type of the service, a status of the service, and a most recent event that occurred with respect to the service. Status information for a service may indicate that the service is currently functioning properly (e.g., “OK”) or that an error has occurred (e.g., “PAPERJAM”).

An error may be an error of the corresponding service or of the corresponding device. An error does not necessarily indicate that the service and/or device is not capable of processing requests. For example, although an MFP is experiencing a paper jam, the MFP may process requests intended for other services provided by the MFP, such as a fax service or a scan service. As another example, a storage server may generate status information that indicates that the storage server has, or will soon, run out of memory. However, the storage server may have access to additional (e.g., backup) storage so that the storage server may still process storage requests.

Each entry 312 in service status view 310 also comprises two interface objects: a view radio button 316 and a remove radio button 318. User selection of a view radio button 316 causes monitoring application 104 to display a new window that includes additional details about the corresponding service and/or device, such as, for example, a description of the corresponding service, other services provided by the same device, and a history of the events that occurred with respect to the corresponding service (or at least more events than are shown in event history view 320).

User selection of a remove radio button 318 causes monitoring application 104 to remove the corresponding entry 312 from service status view 310. For example, user selection of the remove button corresponding to the print service of device2 causes monitoring application 104 to remove entry 312C from service status view 310.

Service status view 310 may also display additional information, such as the total number of devices that are monitored by monitoring application 104, the total number of services that are monitored by monitoring application 104, and the total number of errors detected. In the depicted example, three devices and four services are monitored and one error is detected.

### Event History View

Event history view 320 displays information about the most recently occurred events for which monitoring application 104 is currently subscribed. Event history view 320 may display information about events that have been generated by multiple services. Alternatively, event history view 320 may display information only about events that a single service has generated. Such a single service may be a service whose corresponding entry 312 in service status view 310 (1) is selected or (2) has the associated “view” button selected. For example, if a user selects entry 312B, then event history view 320 displays information about the events that the scan service of device1 has generated.

The displayed information in event history view 320 may be organized into entries 322A-B. Each entry 322 corresponds to a different event that has been generated. For example, if a user selects entry 312B in service status view 310, then the events that the scan service of device1 has generated is displayed in event history view 320. In the depicted example, the scan service of device1 generated at least two events: event1 and event2. Each entry 322 may also indicate a date and time of when the event occurred and/or when monitoring application 104 received the notification corresponding to the event.

### Available Events View

Available events view 330 displays information about events that a particular service is capable of generating. The displayed information may be organized into entries 332A-D. Each entry 332 corresponds to a different event. For example, if a user selects entry 312B in service status view 310, then the events that the scan service of device1 is capable of generating is displayed in available events view 330. In the depicted example, the scan service of device1 is capable of generating four events: event1, event2, event3, and event4. Each entry 332 includes a “subscribe” button and an “alert” button.

In the depicted example, the “subscribe” buttons are two-state buttons that display a current state—either “Yes” or “No”. For example, based on the “subscribe” buttons, a user can determine that monitoring application 104 is currently subscribed to event1 and event4, but not to event2 or event3. User selection of the “subscribe” button causes monitoring application 104 to subscribe to or unsubscribe from the corresponding event. For example, if a user selects the “subscribe” button corresponding to event1, then monitoring application 104 sends an unsubscribe request to the scan service of device1. If the unsubscribe request is successful, then the “subscribe” button of the entry corresponding to event1 changes to “No”. Monitoring application 104 ceases to receive notifications corresponding to event1.

An “alert” button in available events view 330 allows a user to specify parameters when subscribing to the corresponding event. Such parameters may be defined in the WSDL of the corresponding service. For example, event2 in available events view 330 may correspond to a scan available event. User selection of the “alert” button corresponding to event2 causes monitoring application 104 to display a new window or frame to allow a user to input a scan destination and a set of security parameters, such as a password. The scan destination indicates a location where a scanned document is to be sent and/or which device is to be notified of the scanned document. The location may be the computer executing monitoring application 104 (e.g., network device 108) or another machine. The user on that machine may be requested to enter a password in order to view and access the scanned document.

As another example, a particular event that a print service can generate may be a low toner event. The print service may be able to generate a different low toner event for different levels. For example, a low toner event may be generated when the toner level reaches 25%, when the toner level reaches 10%, when the toner level reaches 5%, and when the toner level reaches 0%. Thus, user selection of an “alert” button, corresponding to the low toner event, in available events view 330, causes monitoring application 104 to display a new window or frame to allow a user to select one or more of the above toner levels so that the user is notified of the event(s) when the toner level reaches the one or more selected toner levels.

### Storing and Maintaining Status and Event Information

In an embodiment of the invention, storage is provided for storing and maintaining status and event information about the different services that are monitored by monitoring application 104. The storage may be local or remote with respect to monitoring application 104.

In an embodiment of the invention, status and event information pertaining to a particular service is stored in association with the particular service. In a related embodiment, status and event information pertaining to services that are provided by the same WSD-enabled device are stored in association with that WSD-enabled device.

There are numerous ways in which status and event information may be stored. Embodiments of the invention are not limited to any particular way. For example, such information may be stored in relational tables that are managed by a database server. As another example, status and event information may be stored in objects that are managed by a filesystem.

To further the object example, an object may represent a particular service. Attributes of the object correspond to attributes of the service. One attribute of the object may be a binary value that represents whether the service is currently being monitored. Other attributes of the object may include the name of the service, the type of the service, the name of the device that provides the service, the type of the device, and the current status of the service.

Another attribute of the object may be a linked list of entries. Each entry of the linked list may correspond to an event notification that the service has generated previously. The linked list may be ordered based on when the event notification was sent by the service or when the monitoring service received the event notification. In this way, the event history of a particular service may be determined relatively quickly by identifying the object associated with the particular service, identifying the attribute corresponding to the linked list of entries that correspond to previously generated events, and traversing the linked list.

Another attribute of the object may be an array whose elements (e.g., objects) correspond to different types of events that the service is capable of generating. Each element of the array may indicate whether monitoring application 104 is currently subscribed to the corresponding event. Each element of the array may also include a reference to each entry, in the linked list (described above), that corresponds to the event to which the element corresponds. For example, an object may represent the scan service of device1. An element in the array attribute of the object corresponds to event1. The element includes numerous references to entries (i.e., in the linked list attribute of the object) that correspond to event1.

### Benefits

Significant benefits may result from embodiments of the invention. For example, a monitoring application as disclosed herein (e.g., monitoring application 104) allows an IT administrator to monitor multiple WSD-enabled devices and services from one easy to use interface. Also, the monitoring application leverages the implementation of Web services specifications on the devices, such as WS-Discovery and WS-Eventing. Additionally, the monitoring application is developed in a platform-independent way and, thus, can monitor any type of WSD-enabled device.

Traditional network management systems (NMS) use Simple Network Management Protocol (SNMP) to manage multiple devices on a network. For network management, an administrator is required to install an agent on each device and configure the agent to report to a network manager process executing at a central location. Essentially, both the network manager and the agents must be configured by a network administrator. Alternatively, WSD-enabled devices do not require configuring. WSD-enabled devices are effectively “pre-configured” to communicate with other web services that implement core Web service specifications, such as WS-Discovery, WS-MetadataExchange, and WS-Eventing.

Also, according to traditional NMS, managed devices in a network are monitored at the device level, and not at the service level. This is so because devices that a NMS manages are single function devices, such as routers, switches, and gateways. Alternatively, WSD-enabled devices may provide multiple services and, thus, in embodiments of the invention, each service that a WSD-enabled device provides is monitored.

Furthermore, traditional NMS lack many security measures, such as message encryption. In contrast, according to embodiments of the invention, a WSD-enabled device implements and uses WS-Security or other security mechanisms to authenticate itself and/or to encrypt messages (e.g., event notifications) that are sent to the monitoring application. Only the monitoring application is able to decrypt such messages. In this way, the communication of sensitive information from a WSD-enabled is kept secure. An example of another security mechanism is Transport Layer Security (TLS).

### Implementation Mechanisms

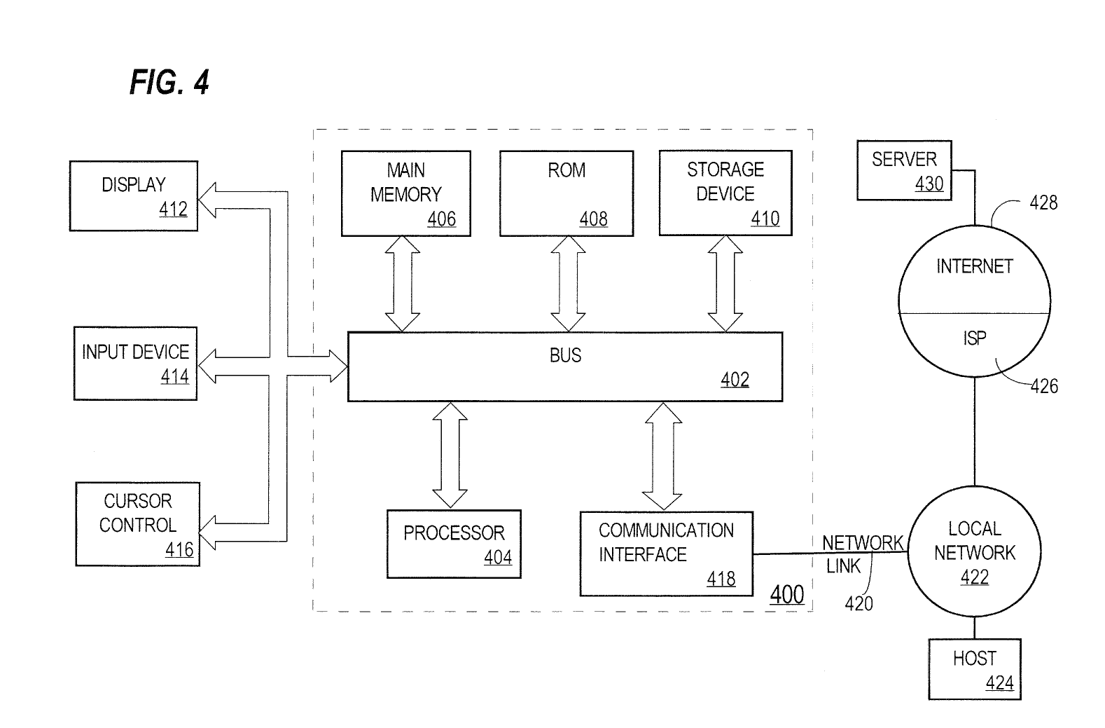

Embodiments of the invention may be implemented on any type of computing architecture or platform. For purposes of explanation, FIG. 4 depicts a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for monitoring multiple Web services (WS)-enabled devices, the computer-implemented method comprising:
receiving, over a network, a first discovery message from a first WS-enabled device and a second discovery message from a second WS-enabled device;
wherein the first discovery message and the second discovery message conform to a WS discovery protocol;
wherein the first discovery message indicates at least a first address of the first WS-enabled device and a first set of one or more services that the first WS-enabled device provides;
wherein the second discovery message indicates at least a second address of the second WS-enabled device and a second set of one or more services that the second WS-enabled device provides;
receiving, over the network, one or more first metadata messages about one or more services of the first set of services;
receiving, over the network, one or more second metadata messages about one or more services of the second set of services;
wherein the one or more services of the first set of services and the one or more services of the second set of services comprise a plurality of services;
wherein each of the one or more first metadata messages and the one or more second metadata messages (1) conforms to a WS metadata exchange protocol and (2) indicates a set of events that the corresponding service is capable of generating;
sending, over the network, a first subscription request, according to a WS eventing protocol, to a first service of the first set of services, wherein the first subscription request is to subscribe for a first event that the first service is capable of generating;
sending, over the network, a second subscription request, according to the WS eventing protocol, to a second service of the second set of services, wherein the second subscription request is to subscribe for a second event that the second service is capable of generating;
receiving, over the network, a plurality of events from the first service and the second service;
storing and maintaining information about the plurality of events;
displaying, via a graphical user interface, event data that indicates that the plurality of events have been generated; and
displaying, via the graphical user interface, status data that indicates a status of the first service and the second service.

2. The method of claim 1, wherein at least one of the first WS-enabled device or the second WS-enabled device provides multiple services.

3. The method of claim 1, further comprising:
sending, over the network one or more discovery request messages, wherein the first and second discovery messages are received in response to the one or more discovery request messages.

4. The method of claim 3, wherein the one or more discovery request messages are sent automatically and not in response to user input.

5. The method of claim 1, further comprising:
sending one or more first metadata requests to the one or more services of the first set of services, wherein the one or more first metadata messages are received in response to the one or more first metadata requests; and
sending one or more second metadata requests to the one or more services of the second set of services, wherein the one or more second metadata messages are received in response to the one or more second metadata requests.

6. The method of claim 1, further comprising:
displaying, via the graphical user interface, service data that indicates the first set of services and the second set of services.

7. The method of claim 1, further comprising:
displaying, via the graphical user interface, one or more event subscription interface objects, wherein the first and second subscription requests are sent in response to a plurality of selections of the one or more event subscription interface objects.

8. The method of claim 1, further comprising:
displaying, via the graphical user interface, a discovery interface object; and
in response to a user selection of the discovery interface object, sending a multicast message over the network;
wherein at least one of the first discovery message or the second discovery message is received in response to the multicast message.

9. The method of claim 1, wherein the graphical user interface comprises an event history view that displays only information about a set of events that were generated by one or more services of the plurality of services.

10. The method of claim 9, wherein the set of events were generated by a particular service of the plurality of services.

11. The method of claim 9, wherein the set of events were generated by multiple services of the plurality of services.

12. The method of claim 1, wherein the graphical user interface comprises an available events view that displays only information about all the events that a particular service, of the plurality of services, is capable of generating.

13. The method of claim 1, further comprising displaying, via the graphical user interface, an add service interface object, wherein status information of a particular service of the plurality of services is displayed in response to a user selection of the add service interface object.

14. The method of claim 1, further comprising displaying, via the graphical user interface, a remove service interface object, wherein status information of a particular service of the plurality of services is removed from the graphical user interface in response to a user selection of the remove service interface object.

15. The method of claim 1, further comprising displaying, via the graphical user interface, an interface object for each of the plurality of events that, when selected, indicates that the corresponding events has been acknowledged by a user.

16. A machine-readable medium carrying instructions for monitoring multiple Web services (WS)-enabled devices, wherein the instructions, when executed by one or more processors, cause the one or more processors to perform:
receiving, over a network, a first discovery message from a first WS-enabled device and a second discovery message from a second WS-enabled device;
wherein the first discovery message and the second discovery message conform to a WS discovery protocol;
wherein the first discovery message indicates at least a first address of the first WS-enabled device and a first set of one or more services that the first WS-enabled device provides;
wherein the second discovery message indicates at least a second address of the second WS-enabled device and a second set of one or more services that the second WS-enabled device provides;
receiving, over the network, one or more first metadata messages about one or more services of the first set of services;
receiving, over the network, one or more second metadata messages about one or more services of the second set of services;
wherein the one or more services of the first set of services and the one or more services of the second set of services comprise a plurality of services;
wherein each of the one or more first metadata messages and the one or more second metadata messages (1) conforms to a WS metadata exchange protocol and (2) indicates a set of events that the corresponding service is capable of generating;
sending, over the network, a first subscription request, according to a WS eventing protocol, to a first service of the first set of services, wherein the first subscription request is to subscribe for a first event that the first service is capable of generating;
sending, over the network, a second subscription request, according to the WS eventing protocol, to a second service of the second set of services, wherein the second subscription request is to subscribe for a second event that the second service is capable of generating;
receiving, over the network, a plurality of events from the first service and the second service;
storing and maintaining information about the plurality of events;
displaying, via a graphical user interface, event data that indicates that the plurality of events have been generated; and
displaying, via the graphical user interface, status data that indicates a status of the first service and the second service.

17. An apparatus for monitoring multiple Web services (WS)-enabled devices, the apparatus comprising:
one or more processors;
a machine-readable medium carrying instructions which, when executed by the one or more processors, cause the one or more processors to perform:
receiving, over a network, a first discovery message from a first WS-enabled device and a second discovery message from a second WS-enabled device;
wherein the first discovery message and the second discovery message conform to a WS discovery protocol;
wherein the first discovery message indicates at least a first address of the first WS-enabled device and a first set of one or more services that the first WS-enabled device provides;
wherein the second discovery message indicates at least a second address of the second WS-enabled device and a second set of one or more services that the second WS-enabled device provides;
receiving, over the network, one or more first metadata messages about one or more services of the first set of services;
receiving, over the network, one or more second metadata messages about one or more services of the second set of services;
wherein the one or more services of the first set of services and the one or more services of the second set of services comprise a plurality of services;
wherein each of the one or more first metadata messages and the one or more second metadata messages (1) conforms to a WS metadata exchange protocol and (2) indicates a set of events that the corresponding service is capable of generating;
sending, over the network, a first subscription request, according to a WS eventing protocol, to a first service of the first set of services, wherein the first subscription request is to subscribe for a first event that the first service is capable of generating;
sending, over the network, a second subscription request, according to the WS eventing protocol, to a second service of the second set of services, wherein the second subscription request is to subscribe for a second event that the second service is capable of generating;
receiving, over the network, a plurality of events from the first service and the second service;
storing and maintaining information about the plurality of events;
displaying, via a graphical user interface, event data that indicates that the plurality of events have been generated; and
displaying, via the graphical user interface, status data that indicates a status of the first service and the second service.
